(19) United States
(12) Patent Application Publication
(10) Pub. No.: US 2020/0212681 A1
(43) Pub. Date: Jul. 2, 2020

(54) METHOD, APPARATUS AND STORAGE MEDIUM FOR TRANSMISSION NETWORK EXPANSION PLANNING CONSIDERING EXTREMELY LARGE AMOUNTS OF OPERATION SCENARIOS

(71) Applicant: Tsinghua University, Beijing (CN)

(72) Inventors: Zhenyu Zhuo, Beijing (CN); Ning Zhang, Beijing (CN); Yi Wang, Beijing (CN); Chongqing Kang, Beijing (CN); Qing Xia, Beijing (CN)

(21) Appl. No.: 16/732,441

(22) Filed: Jan. 2, 2020

(30) Foreign Application Priority Data
Jan. 2, 2019 (CN) 201910000559.7

(51) Int. Cl. H02J 3/38; G06Q 50/06; G06Q 10/04; G06Q 10/06

(52) U.S. Cl. CPC H02J 3/381; G06Q 50/06; G06Q 10/04; G06F 17/11; H02J 2203/20; H02J 2300/24; H02J 2300/28; G06Q 10/06375

(57) ABSTRACT

A method, an apparatus and a storage medium for transmission network expansion planning considering extremely large amounts of operation scenarios is provided. The method comprises establishing an optimization model for transmission network expansion planning, the optimization model including an objective function for minimizing the sum of investment costs for the transmission lines and expected values of operation costs in the power transmission network, solving the optimization model to obtain an optimal investment decision variable; and determining the transmission network expansion planning based on the optimal investment decision variable.

### CROSS REFERENCE TO RELATED APPLICATION

This application claims priority to Chinese Patent Application No. 201910000559.7, filed with the State Intellectual Property Office of P. R. China on Jan. 2, 2019, the entire disclosure of which is incorporated herein by reference.

### TECHNICAL FIELD

The present disclosure relates to a technical field of transmission network expansion planning in the power system, and in particular to a method, an apparatus and a storage medium for transmission network expansion planning considering extremely large amounts of operation scenarios.

### BACKGROUND

With the continuous depletion of fossil energy and increasing environmental pollution and climate change in countries around the world, the proportion of low-carbon and clean renewable energy (such as wind power, photovoltaic, etc.) in the power system is increasing rapidly. According to the report of the national energy administration, by the end of 2017, the installed capacity of renewable energy generation in China had reached 650 million kilowatts, with a year-on-year increase of 14%. Among them, the installed capacity of wind power generation was 164 million kilowatts, and the installed capacity of photovoltaic (PV) power generation was 130 million kilowatts, with a year-on-year increase of 10.5% and 68.7%, respectively. High renewable energy penetration will become an important feature of modem power systems.

In the case of high renewable energy penetration, due to the intermittent characteristics of PV and wind power output itself, the power system will present the features of diversified operation modes. With less renewable energy connected to the grid, the operation pattern of the whole power system is relatively fixed due to the relatively regular net load pattern. Therefore, in traditional power system planning, only typical load curves of different seasons need to be considered. However, in a power system with the high renewable energy penetration, the operation modes of the whole power system will become more diversified due to the large uncertainty in the supply side and the demand side. As a result, the traditional power system planning method based on the typical load curve of seasons is difficult to guide the system planning and operations, so it is highly demanded for a transmission network expansion planning method under the background of strong uncertainty.

The intermittent output of renewable energy has obvious randomness and volatility. At present, modeling the uncertainty of intermittent energy output mainly includes statistical probability distribution model, uncertainty interval model and discrete scenario model.

The statistical probability distribution model method, for example, as described in the reference document of Qiu, Jing, et al. “A risk-based approach to multi-stage probabilistic transmission network planning.” IEEE Transactions on Power Systems 31.6 (2016): 4867-4876, proposes a uncertainty power grid planning with a statistical probability model. Because most of the models are built in the form of complex nonlinear functions with integral and differential functions, no commercial solver is available for solving those constraints directly. In most cases, such models cannot be directly applied to the decision-making of power system planning and operation.

The uncertainty interval model method only takes upper and lower limits of uncertain variables and ignores the probability distribution of them. For example, the reference document Jabr, R. A. “Robust transmission network expansion planning with uncertain renewable generation and loads.” IEEE Transactions on Power Systems 28.4 (2013): 4558-4567 proposes a robust programming technology which characterizes uncertainty variables with uncertainty intervals, and establishes models to find an optimal planning scheme to deal with the worst scenario in the interval. Although the modeling method with such an interval is simple, the solving process of the robust model is extremely complex and it is difficult to guarantee the global optimality of the solutions due to the existence of bilinear problem in the lower level. Moreover, because the planning results are optimal only for the worst scenarios, the calculation results are always too conservative. Further, the robustness and economy largely depend on the choice of interval size.

The discrete scenario model method is to discretize the statistical probability distribution model and to obtain extremely large amounts of scenarios through sampling, so as to approximate the uncertainty of intermittent energy output. The final planning model seeks to minimize the expected value of operation cost for scenarios. The discrete scenario model method intends to replace the uncertain variables with multiple deterministic scenarios. Therefore, it is simple and has clear physical meaning. However, the stochastic optimization based on the extremely large amounts of scenarios may result in a huge computational burden. In order to reduce the complexity of computation, it is necessary to reduce the number of scenarios and preserve only a few typical valuable scenarios. For example, the reference document of Zhan, Junpeng, C. Y. Chung, and Alireza Zare. “A fast solution method for stochastic transmission expansion planning.” IEEE Transactions on Power Systems 32.6 (2017): 4684-4695 proposes a scenario reduction technology. Due to ignoring parts of uncertainty information, the accuracy of uncertainty representation through the representative scenarios is reduced, which brings large errors into the calculated operation costs and eventually affects the planning results. In addition, because scenarios are reduced in advance, and then the reduced scenarios are integrated into the transmission network expansion planning model, only the reduced scenarios are used in the model. In such a case, the errors are inherent in the system and cannot be eliminated by optimization algorithm.

In addition, the present disclosure also relates to the following related arts.

1. Random number generation technology: the technology generates random numbers evenly distributed between 0 and 1. At present, standard functions for generating random numbers may be provided in function libraries of many computer languages, such as C, MATLAB, Java, etc.

2. Decomposition technology of mixed integer linear programming problem: the technology decomposes a large-scale mixed integer linear programming problem into an upper-layer integer programming problem with smaller dimension and multiple lower-layer linear programming problems. The upper-layer problem and the lower-layer problems may be solved respectively, and alternate iterations are performed to obtain an optimal solution. Common decomposition techniques include Benders Decomposition method, Dantzig Wolfe decomposition method and so on. In this disclosure, the Benders Decomposition method is taken as an example to perform the decomposition of large-scale mixed integer linear programming problems.

3. Computer solving technology of linear programming problem: the technology solves the linear programming problem efficiently through a computer, and obtains an optimal solution of the programming problem, constraint sensitivity coefficient and other important information. The disclosure takes the CPLEX linear programming method package of IBM company as an example to solve the linear programming problem in the disclosure.

### SUMMARY

The purpose of the present disclosure is to propose a method, an apparatus and a storage medium for transmission network expansion planning considering extremely large amounts of operation scenarios. Considering extremely large amounts of operation scenarios, the present disclosure can improve calculation efficiency of stochastic transmission network planning problem and accelerate the solving of models. The method can ensure global optimality of planning results. The practical application of the stochastic planning method can be widespread by using the scenario reduction method with embedded random variables.

In one aspect, the present disclosure provides a method for transmission network expansion planning considering extremely large amounts of operation scenarios, including:

establishing an optimization model for transmission network expansion planning, the optimization model including an objective function for minimizing the sum of investment costs for the transmission lines and expected values of operation costs in the power transmission network, expressed by the following expression:

$$min {\sum }_{l ∈ {Ω}_{L N}} {c}_{l} {u}_{l} + {\sum }_{s ∈ {Ω}_{S}} {α}_{s} {\sum }_{g ∈ {Ω}_{G}} {\sum }_{t ∈ T} F ( {p}_{g}^{s , t} ) + {\sum }_{s ∈ {Ω}_{S}} {α}_{s} {\sum }_{n ∈ {Ω}_{N}} {\sum }_{t ∈ T} {C}^{Cur} {D}_{n}^{s , t} ,$$

wherein, l indicates the serial number of a line in the power system, Ω_{LN} indicates a set of candidate lines in the power system, cₗ indicates the investment costs of a candidate line l, uₗ indicates an investment decision variable of the line l, s indicates the serial number of an operation scenario in the power system. Ω_{S} indicates a set of the operation scenarios in the power system, αₛ indicates the probability of an operation scenario s having a value equal to a reciprocal of the number of times the operation scenario s has occurred, g indicates the serial number of a thermal power generator or a hydropower generator in the power system, Ω_{G} indicates a set of the thermal power generators and the hydropower generators in the power system, t indicates the operation period of the power system, T indicates the number of operation periods contained in each operation scenario, P_{g}^{s,t} indicates the output power of the thermal power generator or the hydropower generator g during the operation period t in the operation scenario s, F(P_{g}^{s,t}) indicates the operation costs of the thermal power generator or the hydropower generator g when the output power is P_{g}^{s,t}, n indicates the serial number of a node in the power system, Ω_{N} indicates a set of nodes in the power system, C^{Cur} indicates load-shedding costs at the node, and Dₙ^{s,t} indicates the load-shedding amount at the node n during the operation period t in the operation scenario s

solving the optimization model to obtain an optimal investment decision variable; and

determining the transmission network expansion planning based on the optimal investment decision variable.

In another aspect, the present disclosure further provides an apparatus for transmission network expansion planning considering extremely large amounts of operation scenarios, including: one or more processors, and a storage device, configured to store one or more programs, wherein, when the one or more programs are executed by the one or more processors, the one or more processors are configured to implement the above method for transmission network expansion planning considering extremely large amounts of operation scenarios.

In yet another aspect, the present disclosure further provides a non-transitory computer readable storage medium having a computer program stored thereon, wherein, when the program is executed by a processor, the program implements the above method for transmission network expansion planning considering extremely large amounts of operation scenarios.

The method and apparatus for transmission network expansion planning considering extremely large amounts of operation scenarios according to the present disclosure may solve the computational difficulty due to extremely large amounts of scenarios for outputting renewable energy when planning lines in a power transmission network. The core of the present disclosure is to introduce a Monte Carlo random sampling process where partial operation calculation units are solved, and the situation of the whole is inferred based on the local characteristics. Compared with complex clustering algorithms, the present disclosure has the advantages of simple process, definite target, high calculation efficiency and better results. And to a certain extent, it ensures the effectiveness to describe the overall situation. As long as a reasonable number of samples are set and repeated in continuous iterations, the overall information can be better preserved, which allows to eliminate inherent errors can be eliminated without omitting critical combinations of scenarios and load days too much, thereby ensuring the robustness of solutions and high efficiency of calculation. The present disclosure may be applied to effectively solve the computational difficulty due to extremely large amounts of scenarios for outputting renewable energy when planning lines in a power transmission network. Consequently, in the process of power system expansion planning, an efficient model-solving method considering extremely large amounts of operation scenarios is required, to accelerate the solving of model and to facilitate practical applications of grid planning method with uncertainty, with the calculation accuracy and optimal solution unchanged.

### BRIEF DESCRIPTION OF THE DRAWINGS

FIG. 1 shows a flow chart of a method for transmission network expansion planning considering extremely large amounts of operation scenarios according to an embodiment of the present disclosure.

FIG. 2 shows a flow chart of a solving process for the optimization model according to an embodiment of the present disclosure.

FIG. 3 show a schematic diagram of an apparatus for transmission network expansion planning considering extremely large amounts of operation scenarios according to an embodiment of the present disclosure.

FIG. 4 show a schematic diagram of an exemplary device for implementing embodiments of the present disclosure.

### DETAILED DESCRIPTION

The present disclosure proposes a method for transmission network expansion planning considering extremely large amounts of operation scenarios. In this method, the scenario reduction method with embedded random variables is used to improve the calculation efficiency of stochastic power grid planning problem and ensure the optimization of planning results.

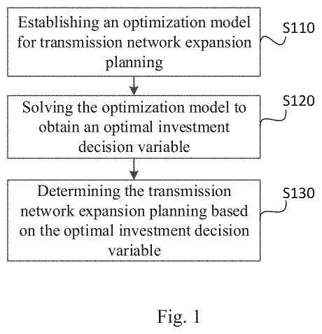

FIG. 1 shows a flow chart of a method for transmission network expansion planning considering extremely large amounts of operation scenarios according to an embodiment of the present disclosure. As shown in FIG. 1, the method includes the following steps.

At step S110, an optimization model for transmission network expansion planning is established. The optimization model includes an objective function for minimizing the sum of investment costs for the transmission lines and expected values of operation costs in the power transmission network, expressed by the following expression:

$$min {\sum }_{l ∈ {Ω}_{L N}} {c}_{l} {u}_{l} + {\sum }_{s ∈ {Ω}_{S}} {α}_{s} {\sum }_{g ∈ {Ω}_{G}} {\sum }_{t ∈ T} F ( {p}_{g}^{s , t} ) + {\sum }_{s ∈ {Ω}_{S}} {α}_{s} {\sum }_{n ∈ {Ω}_{N}} {\sum }_{t ∈ T} {C}^{Cur} {D}_{n}^{s , t} . \qquad ( 1 )$$

Here, l indicates the serial number of a line in the power system, Ω_{LN} indicates a set of candidate lines in the power system, cₗ indicates the investment costs of a candidate line l, uₗ indicates an investment decision variable of the line l, s indicates the serial number of an operation scenario in the power system, Ω_{S} indicates a set of the operation scenarios in the power system, αₛ indicates the probability of an operation scenario s, having a value equal to a reciprocal of the number of times the operation scenario s has occurred, g indicates the serial number of a thermal power generator or a hydropower generator in the power system, Ω_{G} indicates a set of the thermal power generators and the hydropower generators in the power system, t indicates the operation period of the power system, T indicates the number of operation periods contained in each operation scenario, l indicates the output power of the thermal power generator or the hydropower generator g during the operation period t in the operation scenario s, F(P_{g}^{s,t}) indicates the operation costs of the thermal power generator or the hydropower generator g when the output power is P_{g}^{s,t}, n indicates the serial number of a node in the power system, Ω_{N} indicates a set of nodes in the power system, C^{Cur} indicates load-shedding costs at the node, and DLₙ^{s,t} indicates the load-shedding amount at the node n during the operation period t in the operation scenario s.

For example, in a case in which each operation day is taken as a scenario, T is 24, which indicates a time-period in a 24-hour system.

Further, in the above expression, uₗ=0 may indicate that the line is not to be invested, and uₗ=1 may indicate that the line is to be invested.

In the embodiments, constraints of the optimization model may include the following constraints.

1) A node power balance constraint requiring that the input power and the output power at each node in the power system be equal, may be expressed by the following expression:

$${\sum }_{g ∈ {Ω}_{G} ( n )} {P}_{g}^{s , t} + {\sum }_{r ∈ {Ω}_{R} ( n )} {P}_{r}^{s , t} - {\sum }_{l ∈ {Ω}_{L} ( n 1 )} {f}_{l}^{s , t} + {\sum }_{l ∈ {Ω}_{L} ( n 2 )} {f}_{l}^{s , t} = {L}_{n}^{s , t} + {D}_{n}^{s , t} . \qquad ( 2 )$$

Here, l indicates the serial number of a line in the power system, g indicates the serial number of the thermal power generator or the hydropower generator in the power system, n indicates the serial number of the node in the power system, t indicates the operation period of the power system, s indicates the serial number of an operation scenario in the power system, Ω_{G} indicates a set of the thermal power generators and the hydropower generators in the power system, P_{g}^{s,t} indicates the output power of the thermal power generator or the hydropower generator g during the operation period t in the operation scenario s, r indicates the serial number of a wind power generator or a photovoltaic power generator in the power system, Ω_{R} indicates a set of the wind power generators and the photovoltaic power generators in the power system, Pᵣ^{s,t} indicates the output power of the wind power generator or the photovoltaic power generator r during the operation period t in the operation scenario s, Ω_{L} indicates a set of all the lines in the power system, including a set of candidate lines Ω_{LN} and a set of existing lines Ω_{LE}, i. e. Ω_{L}={Ω_{LE},Ω_{LN}}, n1 indicates the start node of the line l in the power system, n2 indicates the end node of the line l in the power system, fₗ^{s,t} indicates the power flow on the line l during the operation period t in the operation scenario s, Lₙ^{s,t} indicates the power load demand at the node n during the operation period t in the operation scenario s, and Dₙ^{s,t} indicates the load-shedding amount at the node n during the operation period t in the operation scenario s.

2) A power flow constraint for existing lines in the power system, may be expressed by the following expression:

$${f}_{l}^{s , t} = \frac{{θ}_{l +}^{s , t} - {θ}_{l -}^{s , t}}{{x}_{l}} , ∀ l ∈ {Ω}_{LE} . \qquad ( 3 )$$

Here, l indicates the serial number of a line in the power system, fₗ^{s,t} indicates the power flow on the line l during the operation period t in the operation scenario s, θₗ₊^{s,t} and θₗ₋^{s,t} indicates phase angles of the start node and the end node of the line l during the operation period t in the operation scenario s, xₗ indicates the reactance of the line l, and Ω_{LE} indicates a set of existing lines in the power system.

3) A power flow constraint for candidate lines in the power system, may be expressed by the following expression:

$$( {u}_{l} - 1 ) M \leq {f}_{l}^{s , t} - \frac{{θ}_{l +}^{s , t} - {θ}_{l -}^{s , t}}{{x}_{l}} \leq ( 1 - {u}_{l} ) M , ∀ l ∈ {Ω}_{L N} . \qquad ( 4 )$$

Here, l indicates the serial number of a line in the power system, uₗ indicates the investment decision variable of the line l, M indicates the sum of the maximum capacities of all the lines in the power system, fₗ^{s,t} indicates the power flow on the line l during the operation period t in the operation scenario s, θₗ₊^{s,t} and θₗ₋^{s,t} indicates phase angles of the start node and the end node of the line l during the operation period t in the operation scenario s, xₗ indicates the reactance of the line l, and Ω_{LN} indicates a set of candidate lines in the power system.

4) A constraint for load-shedding amount at a node in the power system, may be expressed by the following expression:

0≤Dₙ^{s,t}≤Dₙ^{max} (5).

Here, Dₙ^{s,t} indicates the load-shedding amount at the node n during the operation period t in the operation scenario s, and Dₙ^{max} indicates the maximum load-shedding amount at the node n.

5) A power flow capability constraint for existing lines in the power system, may be expressed by the following expression:

−fₗ^{max}≤fₗ^{s,t}≤fₗ^{max},∀l∈Ω_{LE} (6),

Here, fₗ^{s,t} indicates the power flow on the line l during the operation period t in the operation scenario s, fₗ^{max} indicates the maximum value of the power flow on the line l, and Ω_{LE} indicates a set of existing lines in the power system.

6) A power flow capability constraint for candidate lines in the power system, may be expressed by the following expression:

−uₗ*fₗ^{max}≤fₗ^{s,t}≤uₗ*fₗ^{max},∀l∈Ω_{LN} (7).

Here, uₗ indicates the investment decision variable of the line l, fₗ^{s,t} indicates the power flow on the line l during the operation period t in the operation scenario s, fₗ^{max} indicates the maximum value of the power flow on the line l, and Ω_{LN} indicates a set of candidate lines in the power system.

7) A constraint for upper and lower limits of output power of a thermal power generator or a hydropower generator in the power system, may be expressed by the following expression:

P_{g}^{min}≤P_{g}^{s,t}≤P_{g}^{max},∀g,∀t,∀s (8)

Here, g indicates the serial number of a thermal power generator or a hydropower generator in the power system, t indicates the operation period of the power system, s indicates the serial number of an operation scenario in the power system, P_{g}^{s,t} indicates the output power of the thermal power generator or the hydropower generator g during the operation period t in the operation scenario s, and P_{g}^{min} and P_{g}^{max} indicate the upper and lower limits of the output power of the thermal power generator or the hydropower generator g.

8) A constraint for upper and lower limits of output of a wind power generator or a photovoltaic power generator in the power system, may be expressed by the following expression:

0≤Pᵣ^{s,t}≤P̅ᵣ^{s,t},∀r,∀t,∀s (9).

Here, r indicates the serial number of the wind power generator or the photovoltaic power generator in the power system, t indicates the operation period of the power system, s indicates the serial number of an operation scenario in the power system, Pᵣ^{s,t} indicates the output power of the wind power generator or the photovoltaic power generator r during the operation period t in the operation scenario s, and P̅ᵣ^{s,t} indicates the maximum output power of the wind power generator or the photovoltaic power generator r during the operation period t in the operation scenario s.

At step S120, the optimization model is solved to obtain an optimal investment decision variable.

In this embodiment, the optimization model may be solved based on the Benders decomposition method.

Specifically, the solving process for the optimization model at step S120 may further include the following steps S1201 to S1211.

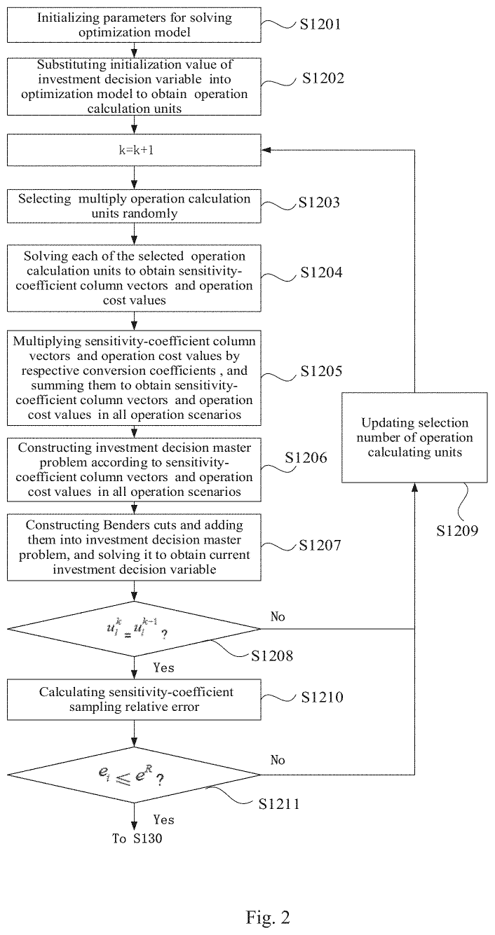

FIG. 2 shows a flow chart of a solving process for the optimization model according to an embodiment of the present disclosure.

As show in FIG. 2, at step S1201, parameters for solving the optimization model are initialized. Here, the number of iteration k is set as k=0, and the initialization value of the investment decision variable uₗ in the optimization model is set as uₗ^{k}=uₗ⁰=0, wherein, k is a positive integer equal to or greater than 0.

Furthermore, the parameters of the solving process for the optimization model further include a sampling number M^{k}, which indicates the number of randomly selected scenarios in each iteration. The parameters initialization step may include setting an initial value M¹ of the sampling number M^{k}.

Furthermore, the parameters of the solving process for the optimization model may further include a learning rate β and an error upper limit e^{R}. The initial values of the learning rate β and the error upper limit e^{R} can be set as necessary. In the subsequent processes, if the algorithm does not converge after one iteration, the number of randomly selected scenarios M^{k} each time will be increased by a product of the learning rate β and the total number of scenarios. If the error of iteration is less than the error upper limit e^{R}, the algorithm ends. The parameters will be described in detail below.

At step S1202, the initialization value of the investment decision variable uₗ^{k}=uₗ⁰=0 is substituted into the optimization model to obtain N^{CallUnit} operation calculation units and each operation calculation unit corresponds to one operation scenario.

At step S1203, in the k-th iteration in which k is equal to or greater than 1, M^{k} operation calculation units are selected from the N^{CallUnit} operation calculation units randomly.

At step S1204 for example, by using the CPLEX linear programming method, each of the selected M^{k} operation calculation units is solved to obtain sensitivity-coefficient column vectors δ^{k} and operation cost values C^{k} for the M^{k} operation calculation units.

Specifically, the m-th operation calculation unit in the selected M^{k} operation calculation units is solved to obtain a sensitivity-coefficient column vector δ^{k,m} and an operation cost value C^{k,m} for the m-th operation calculation unit, m=1, 2, 3 . . . M^{k}. Then, the sensitivity-coefficient column vectors δ^{k} and the operation cost values C^{k} for all the M^{k} operation calculation units are obtained by traversing the M^{k} operation calculation units.

At step S1205, the resultant sensitivity-coefficient column vectors δ^{k} and operation cost values C^{k} for the M^{k} operation calculation units are multiplied by respective conversion coefficients p^{k}. The products are summed to obtain sensitivity-coefficient column vectors \hat{δ}^{k} and operation cost values Ĉ^{k} in all operation scenarios.

Specifically, the sensitivity-coefficient column vectors \hat{δ}^{k} and the operation cost values Ĉ^{k} in all operation scenarios are calculated by the following expressions:

$$\begin{matrix}{\hat{δ}}^{k} = {\sum }_{m = 1}^{{M}^{k}} {p}^{k , m} {δ}^{k , m} , & ( 10 ) \\ {\hat{C}}^{k} = {\sum }_{m = 1}^{{M}^{k}} {p}^{k , m} {C}^{k , m} , & ( 11 ) \\ {p}^{k , m} = \frac{{N}^{CalUnit}}{{M}^{k}} . & ( 12 )\end{matrix}$$

Here, p^{k,m} is a conversion coefficient corresponding to the sensitivity-coefficient column vector δ^{k,m} and the operation cost value C^{k,m} for the m-th operation calculation unit.

At step S1206, an investment decision master problem (upper-level problem) is constructed according to the sensitivity-coefficient column vectors \hat{δ}^{k} and operation cost values Ĉ^{k} in all operation scenarios, for example, by the following expression:

$$min z \\ s . t . {\sum }_{l ∈ {Ω}_{L N}} {c}_{l} {u}_{l} + {\hat{C}}^{1} + {\sum }_{l ∈ {Ω}_{L N}} ( {u}_{l} - {u}_{l}^{0} ) {\hat{δ}}_{l}^{1} \leq z \\ … \\ {\sum }_{l ∈ {Ω}_{L N}} {c}_{l} {u}_{l} + {\hat{C}}^{k + 1} + {\sum }_{l ∈ {Ω}_{L N}} ( {u}_{l} - {u}_{l}^{k - 2} ) {\hat{δ}}_{l}^{k - 1} \leq z \\ {\sum }_{l ∈ {Ω}_{L N}} {c}_{l} {u}_{l} + \hat{{C}^{k}} + {\sum }_{l ∈ {Ω}_{L N}} ( {u}_{l} - {u}_{l}^{k - 1} ) {\hat{δ}}_{l}^{k} \leq z . \qquad ( 13 )$$

Here, z is an auxiliary continuous variable, which satisfies a constraint indicating Benders cut constraints constructed by the sensitivity-coefficient column vectors \hat{δ}^{k} and the operation cost values Ĉ^{k} in all operation scenarios.

At step S1207, Benders cuts are constructed and added into the investment decision master problem, and the investment decision master problem is solved to obtain a current investment decision variable uₗ^{k}.

At step S1208, the current investment decision variable uₗ^{k} is compared with a previous investment decision variable uₗ^{k-1} obtained in the (k−1)th iteration.

When the current investment decision variable uₗ^{k} obtained in the kth iteration is different from the previous investment decision variable uₗ^{k-1} obtained in the (k−1)th iteration, the process proceeds to step S1209.

On the other hand, when the current investment decision variable uₗ^{k} obtained in the kth iteration is identical to the previous investment decision variable uₗ^{k-1} obtained in the (k−1)th iteration, the iteration ends and the process proceeds to step S1210.

At step S1209, the selection number of the operation calculation units is updated to M^{k+1}=M^{k}+βN^{CallUnit}. The number of iteration k is incremented by one, and the process returns to execute step S1202 to step S1207. Here, β is the learning rate.

Next, at step S1210, a sensitivity-coefficient sampling relative error eᵢ is calculated for each sensitivity-coefficient element in the sensitivity-coefficient column vectors \hat{δ}^{k} in all operation scenarios, wherein, ∀0≤i≤N^{inv}, and N^{inv} is dimension of the vector \hat{δ}^{k}.

Specifically, when k sensitivity-coefficient column vectors \hat{δ}^{k} in all operation scenarios are obtained through k iterations, assuming that each sensitivity-coefficient element δₗ^{k} in each of the sensitivity-coefficient column vectors \hat{δ}^{k} in all operation scenarios satisfies an independent and identical distribution, a mean value δ̅ᵢ and a standard deviation \hat{σ}ᵢ are calculated for each sensitivity-coefficient element δₗ^{k} in the k sensitivity-coefficient column vectors \hat{δ}^{k} in all operation scenarios, respectively.

Here, the sensitivity-coefficient sampling relative error eᵢ may be calculated according to the mean value δ̅ᵢ and the standard deviation \hat{σ}ᵢ within a confidence region range of 95% by the following expression:

$${e}_{i} = \frac{\frac{1.96 {\hat{σ}}_{i}}{\sqrt{K}}}{{\overline{δ}}_{i}} . \qquad ( 14 )$$

The confidence range may be set according to specific circumstances.

Next, at step S1211, The resultant sensitivity-coefficient sampling relative error eᵢ is compared with a relative error upper limit e^{R}.

When eᵢ≤e^{R}, ∀0≤i≤N^{inv}, the process proceeds to step S130.

On the other hand, when eᵢ>e^{R}, ∃0≤i≤N^{inv}, the process proceeds to step S1209.

Next, at step S130, the transmission network expansion planning is determined based on the optimal investment decision variable. Specifically, when eᵢ≤e^{R}, ∀0≤i≤N^{inv}, the current investment decision variable uₗ^{k} is outputted as the optimal investment decision variable. That is, the investment decision variable uₗ^{k} which is an optimal solution of the optimization model is outputted to be used as a final scheme for transmission network expansion planning considering extremely large amounts of operation scenarios.

To sum up, a method, an apparatus and a storage medium for transmission network expansion planning considering extremely large amounts of operation scenarios according to the present disclosure may solve the computational difficulty due to extremely large amounts of scenarios for outputting renewable energy when planning lines in a power transmission network. The core of the present disclosure is to introduce a Monte Carlo random sampling process where partial operation calculation units are solved, and the situation of the whole is inferred based on the local characteristics. Compared with complex clustering algorithms, the present disclosure has the advantages of simple process, definite target, high calculation efficiency and better results. And to a certain extent, it ensures the effectiveness to describe the overall situation. As long as a reasonable number of samples are set and repeated in continuous iterations, the overall information can be better preserved, which allows to eliminate inherent errors can be eliminated without omitting critical combinations of scenarios and load days too much, thereby ensuring the robustness of solutions and high efficiency of calculation. The present disclosure may be applied to effectively solve the computational difficulty due to extremely large amounts of scenarios for outputting renewable energy when planning lines in a power transmission network. Consequently, in the process of power system expansion planning, an efficient model-solving method considering extremely large amounts of operation scenarios is required, to accelerate the solving of model and to facilitate practical applications of grid planning method with uncertainty, with the calculation accuracy and optimal solution unchanged.

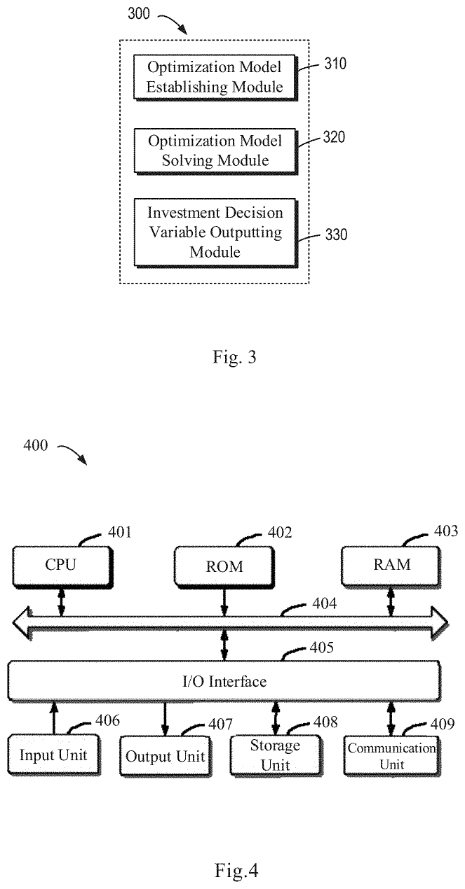

FIG. 3 show a schematic diagram of an apparatus 300 for transmission network expansion planning considering extremely large amounts of operation scenarios according to an embodiment of the present disclosure.

As shown in FIG. 3, the apparatus 300 includes an optimization model establishing module 310, an optimization model solving module 320, and an investment decision variable outputting module 330.

The optimization model establishing module 310 is configured to establish an optimization model for transmission network expansion planning. The optimization model includes an objective function for minimizing the sum of investment costs for the transmission lines and expected values of operation costs in the transmission network, expressed by the above expression (1).

The optimization model solving module 320 is configured to solve the optimization model to obtain an optimal investment decision variable.

The investment decision variable outputting module 330 is configured to determine the transmission network expansion planning based on the optimal investment decision variable.

In the embodiments, the optimization model establishing module 310 may be configured to establish the optimization model based on the constraints (1)-(8) of the optimization model as described above.

In the embodiments, the optimization model solving module 320 may be configured to: initialize parameters for solving the optimization model, wherein the number of iteration k is set as k=0, and the initialization value of the investment decision variable uₗ in the optimization model is set as uₗ^{k}=uₗ⁰=0; substitute the initialization value of the investment decision variable uₗ^{k}=uₗ⁰=0 into the optimization model to obtain N^{CallUnit} operation calculation units, each operation calculation unit corresponding to one operation scenario, wherein, k is a positive integer equal to or greater than 0; in the k-th iteration in which k is equal to or greater than 1, select M^{k} operation calculation units from the N^{CallUnit} operation calculation units randomly; solve each of the selected M^{k} operation calculation units to obtain sensitivity-coefficient column vectors δ^{k} and operation cost values C^{k} for the M^{k} operation calculation units; multiply the resultant sensitivity-coefficient column vectors δ^{k} and operation cost values C^{k} for the M^{k} operation calculation units by respective conversion coefficients p^{k}, and sum the products, to obtain sensitivity-coefficient column vectors \hat{δ}^{k} and operation cost values Ĉ^{k} in all operation scenarios; construct an investment decision master problem according to the sensitivity-coefficient column vectors \hat{δ}^{k} and operation cost values Ĉ^{k} in all operation scenarios; construct Benders cuts and add them into the investment decision master problem, and solve the investment decision master problem, to obtain a current investment decision variable uₗ^{k}; compare the current investment decision variable uₗ^{k} with a previous investment decision variable uₗ^{k-1} obtained in the (k−1)th iteration; when the investment decision variable uₗ^{k} obtained in the kth iteration is different from the investment decision variable uₗ^{k-1} obtained in the (k−1)th iteration, update the selection number of the operation calculation units to M^{k+1}=M^{k}+βN^{CallUnit}, increment the number of iteration k by one, and repeat the above steps, wherein β is the learning rate, or when the current investment decision variable uₗ^{k} obtained in the kth iteration is the same as the previous investment decision variable uₗ^{k-1} obtained in the (k−1)th iteration, calculate a sensitivity-coefficient sampling relative error eᵢ for each sensitivity-coefficient element δᵢ^{k} in the sensitivity-coefficient column vectors \hat{δ}^{k} in all operation scenarios, wherein, ∀0≤i≤N^{inv}, and N^{inv} is dimension of the vector \hat{δ}^{k}; compare the resultant sensitivity-coefficient sampling relative error eᵢ with a relative error upper limit e^{R}; and when eᵢ≤e^{R}, ∀0≤i≤N^{inv}, output the current investment decision variable uₗ^{k} as said optimal investment decision variable, or when eᵢ>e^{R}, ∃0≤i≤N^{inv}, update the selection number of the operation calculation units to M^{k+1}=M^{k}+βN^{CallUnit}, increment the number of iteration k by one, and repeat the above steps.

In the embodiments, the optimization model solving module 320 may further include an operation calculation unit solving module, configured to solve the m-th operation calculation unit in the selected M^{k} operation calculation units to obtain a sensitivity-coefficient column vector δ^{k,m} and an operation cost value C^{k,m} for the m-th operation calculation unit, m=1, 2, 3 . . . M^{k}; and obtain the sensitivity-coefficient column vectors δ^{k} and the operation cost values C^{k} for all the M^{k} operation calculation units by traversing the M^{k} operation calculation units.

In the embodiments, the optimization model solving module 320 may further include a calculation module, configured to calculate the sensitivity-coefficient column vectors \hat{δ}^{k} and the operation cost values Ĉ^{k} in all operation scenarios by the above expressions (10)-(12).

In the embodiments, the optimization model solving module 320 may further include a master problem constructing module, configured to construct the investment decision master problem according to the sensitivity-coefficient column vectors \hat{δ}^{k} and the operation cost values Ĉ^{k} in all operation scenarios, by the above expression (13).

In the embodiments, the optimization model solving module 320 may further include a relative error calculation module, configured, when k sensitivity-coefficient column vectors \hat{δ}^{k} in all operation scenarios are obtained through k iterations, assuming that each sensitivity-coefficient element δᵢ^{k} in each of the sensitivity-coefficient column vectors \hat{δ}^{k} in all operation scenarios satisfies an independent and identical distribution, to calculate a mean value δ̅ᵢ and a standard deviation \hat{σ}ᵢ for each sensitivity-coefficient element δᵢ^{k} in the k sensitivity-coefficient column vectors \hat{δ}^{k} in all operation scenarios, respectively. The one or more processors are further configured to calculate the sensitivity-coefficient sampling relative error eᵢ according to the mean value δ̅ᵢ and the standard deviation \hat{σ}ᵢ within a confidence region range of 95% by the above expression (14).

FIG. 4 show a schematic diagram of an exemplary device 400 for implementing embodiments of the present disclosure.

As illustrated in FIG. 4, the device 400 includes a center processing unit (CPU) 401, capable of executing various appropriate operations and processes according to computer program instructions stored in a read only memory (ROM) 402 or computer program instructions loaded to a random access memory (RAM) 403 from a storage unit 408. In the RAM 403, various programs and date necessary for the operations of the device 400 may also be stored. The CPU 401, the ROM 402, and the RAM 403 may be connected to each other via a bus 404. An input/output (I/O) interface 405 is also connected to the bus 404.

A plurality of components in the device 400 are connected to the I/O interface 405, including: an input unit 406 such as a keyboard, a mouse; an output unit 407 such as various kinds of displays, speakers; a storage unit 408 such as a magnetic disk, an optical disk; and a communication unit 409, such as a network card, a modem, a wireless communication transceiver. The communication unit 409 allows the device 400 to exchange information/data with other devices over a computer network such as the Internet and/or various telecommunication networks.

The processing unit 401 executes the above-mentioned methods and processes. For example, in some embodiments, the method may be implemented as a computer software program, which may be tangibly contained in a machine readable medium, such as the storage unit 408. In some embodiments, a part or all of the computer programs may be loaded and/or installed on the device 400 through the ROM 402 and/or the communication unit 409. When the computer programs are loaded to the RAM 403 and are executed by the CPU 401, one or more steps in the method described above may be executed. Alternatively, in other embodiments, the CPU 401 may be configured to execute the method in other appropriate manners (such as, by means of firmware).

The functions described above may at least partially be executed by one or more hardware logic components. For example, but not being limitative, exemplary types of hardware logic components that may be used include: a field programmable gate array (FPGA), an application specific integrated circuit (ASIC), an application specific standard product (ASSP), a system on chip (SOC), a complex programmable logic device (CPLD) or the like.

Program codes for implementing the method of the present disclosure may be written in any combination of one or more programming languages. These program codes may be provided to a processor or a controller of a general purpose computer, a special purpose computer or other programmable data processing device, such that the functions/operations specified in the flowcharts and/or the block diagrams are implemented when these program codes are executed by the processor or the controller. These program codes may execute entirely on a machine, partly on a machine, partially on the machine as a stand-alone software package and partially on a remote machine or entirely on a remote machine or entirely on a server.

In the context of the present disclosure, the machine-readable medium may be a tangible medium that may contain or store a program to be used by or in connection with an instruction execution system, apparatus, or device. The machine-readable medium may be a machine-readable signal medium or a machine-readable storage medium. The machine-readable medium may include, but not limit to, an electronic, magnetic, optical, electromagnetic, infrared, or semiconductor system, apparatus, or device, or any suitable combination of the foregoing. More specific examples of the machine-readable storage medium may include electrical connections based on one or more wires, a portable computer disk, a hard disk, a RAM, a ROM, an erasable programmable read-only memory (EPROM or flash memory), an optical fiber, a portable compact disk read-only memory (CD-ROM), an optical storage, a magnetic storage device, or any suitable combination of the foregoing.

In addition, although the operations are depicted in a particular order, it should be understood to require that such operations are executed in the particular order illustrated in the drawings or in a sequential order, or that all illustrated operations should be executed to achieve the desired result. Multitasking and parallel processing may be advantageous in certain circumstances. Likewise, although several specific implementation details are included in the above discussion, these should not be construed as limitation of the scope of the present disclosure. Certain features described in the context of separate embodiments may also be implemented in combination in a single implementation. On the contrary, various features described in the context of the single implementation may also be implemented in a plurality of implementations, either individually or in any suitable sub-combination.

Although the subject matter has been described in language specific to structural features and/or methodological acts, it should be understood that the subject matter defined in the appended claims is not limited to the specific features or acts described above. Instead, the specific features and acts described above are merely exemplary forms of implementing the claims.

What is claimed is:

1. A method for transmission network expansion planning considering extremely large amounts of operation scenarios, comprising:
establishing an optimization model for transmission network expansion planning, the optimization model including an objective function for minimizing the sum of investment costs for the transmission lines and expected values of operation costs in the power transmission network, expressed by the following expression:
$$min {\sum }_{l ∈ {Ω}_{L N}} {c}_{l} {u}_{l} + {\sum }_{s ∈ {Ω}_{S}} {α}_{s} {\sum }_{g ∈ {Ω}_{G}} {\sum }_{t ∈ T} F ( {p}_{g}^{s , t} ) + {\sum }_{s ∈ {Ω}_{S}} {α}_{s} {\sum }_{n ∈ {Ω}_{N}} {\sum }_{t ∈ T} {C}^{Cur} {D}_{n}^{s , t} ,$$
wherein, l indicates the serial number of a line in the power system, Ω_{LN} indicates a set of candidate lines in the power system, cₗ indicates the investment costs of a candidate line l, uₗ indicates an investment decision variable of the line l, s indicates the serial number of an operation scenario in the power system, Ω_{S} indicates a set of the operation scenarios in the power system, αₛ indicates the probability of an operation scenario s, having a value equal to a reciprocal of the number of times the operation scenario s has occurred, g indicates the serial number of a thermal power generator or a hydropower generator in the power system, Ω_{G} indicates a set of the thermal power generators and the hydropower generators in the power system, t indicates the operation period of the power system, T indicates the number of operation periods contained in each operation scenario, P_{g}^{s,t} indicates the output power of the thermal power generator or the hydropower generator g during the operation period t in the operation scenario s, F(P_{g}^{s,t}) indicates the operation costs of the thermal power generator or the hydropower generator g when the output power is P_{g}^{s,t}, n indicates the serial number of a node in the power system, Ω_{N} indicates a set of nodes in the power system, C^{Cur} indicates load-shedding costs at the node, and Dₙ^{s,t} indicates the load-shedding amount at the node n during the operation period t in the operation scenario s;
solving the optimization model to obtain an optimal investment decision variable; and
determining the transmission network expansion planning based on the optimal investment decision variable.

2. The method of claim 1, wherein constraints of the optimization model comprise:
1) a node power balance constraint requiring that the input power and the output power at each node in the power system be equal, expressed by the following expression:
$${\sum }_{g ∈ {Ω}_{G} ( n )} {P}_{g}^{s , t} + {\sum }_{r ∈ {Ω}_{R} ( n )} {P}_{r}^{s , t} - {\sum }_{l ∈ {Ω}_{L} ( n 1 )} {f}_{l}^{s , t} + {\sum }_{l ∈ {Ω}_{L} ( n 2 )} {f}_{l}^{s , t} = {L}_{n}^{s , t} + {D}_{n}^{s , t} ,$$
wherein, l indicates the serial number of a line in the power system, g indicates the serial number of the thermal power generator or the hydropower generator in the power system, n indicates the serial number of the node in the power system, t indicates the operation period of the power system, s indicates the serial number of an operation scenario in the power system, Ω_{G} indicates a set of the thermal power generators and the hydropower generators g in the power system, P_{g}^{s,t} indicates the output power of the thermal power generator or the hydropower generator g during the operation period t in the operation scenario s, r indicates the serial number of a wind power generator or a photovoltaic power generator in the power system, Ω_{R} indicates a set of the wind power generators and the photovoltaic power generators in the power system, P_{g}^{s,t} indicates the output power of the wind power generator or the photovoltaic power generator r during the operation period t in the operation scenario s, Ω_{L} indicates a set of all the lines in the power system, including a set of candidate lines Ω_{LN} and a set of existing lines Ω_{LE}, i. e. Ω_{L}={Ω_{LE},Ω_{LN}}, n1 indicates the start node of the line l in the power system, n2 indicates the end node of the line l in the power system, fₗ^{s,t} indicates the power flow on the line l during the operation period t in the operation scenario s, Lₙ^{s,t} indicates the power load demand at the node n during the operation period t in the operation scenario s, and Dₙ^{s,t} indicates the load-shedding amount at the node n during the operation period t in the operation scenario s.
2) a power flow constraint for existing lines in the power system, expressed by the following expression:
$${f}_{l}^{s , t} = \frac{{θ}_{l +}^{s , t} - {θ}_{l -}^{s , t}}{{x}_{l}} , ∀ l ∈ {Ω}_{LE} ,$$
wherein, l indicates the serial number of a line in the power system, fₗ^{s,t} indicates the power flow on the line l during the operation period t in the operation scenario s, θₗ₊^{s,t} and θₗ₋^{s,t} indicates phase angles of the start node and the end node of the line l during the operation period t in the operation scenario s, xₗ indicates the reactance of the line l, and Ω_{LE} indicates a set of existing lines in the power system;
3) a power flow constraint for candidate lines in the power system, expressed by the following expression:
$$( {u}_{l} - 1 ) M \leq {f}_{l}^{s , t} - \frac{{θ}_{l +}^{s , t} - {θ}_{l -}^{s , t}}{{x}_{l}} \leq ( 1 - {u}_{i} ) M , ∀ l ∈ {Ω}_{L N} ,$$
wherein, l indicates the serial number of a line in the power system, uₗ indicates the investment decision variable of the line l, M indicates the sum of the maximum capacities of all the lines in the power system, fₗ^{s,t} indicates the power flow on the line l during the operation period t in the operation scenario s, θₗ₊^{s,t} and θₗ₋^{s,t} indicates phase angles of the start node and the end node of the line l during the operation period t in the operation scenario s, xₗ indicates the reactance of the line l, and Ω_{LN} indicates a set of candidate lines in the power system;
4) a constraint for load-shedding amount at a node in the power system, expressed by the following expression:
0≤Dₙ^{s,t}≤Dₙ^{max},
wherein, Dₙ^{s,t} indicates the load-shedding amount at the node n during the operation period t in the operation scenario s, and Dₙ^{max} indicates the maximum load-shedding amount at the node n;
5) a power flow capability constraint for existing lines in the power system, expressed by the following expression:
−fₗ^{max}≤fₗ^{s,t}≤fₗ^{max},∀l∈Ω_{LE},
wherein, fₗ^{s,t} indicates the power flow on the line l during the operation period t in the operation scenario s, fₗ^{max} indicates the maximum value of the power flow on the line l, and Ω_{LE} indicates a set of existing lines in the power system;
6) a power flow capability constraint for candidate lines in the power system, expressed by the following expression:
−uₗ*fₗ^{max}≤fₗ^{s,t}≤uₗ*fₗ^{max},∀l∈Ω_{LN},
wherein, uₗ indicates the investment decision variable of the line l, fₗ^{s,t} indicates the power flow on the line l during the operation period t in the operation scenario s, fₗ^{max} indicates the maximum value of the power flow on the line l, and Ω_{LN} indicates a set of candidate lines in the power system;
7) a constraint for upper and lower limits of output power of a thermal power generator or a hydropower generator in the power system, expressed by the following expression:
P_{g}^{min}≤P_{g}^{s,t}≤P_{g}^{max},∀g,∀t,∀s,
wherein, g indicates the serial number of a thermal power generator or a hydropower generator in the power system, t indicates the operation period of the power system, s indicates the serial number of an operation scenario in the power system, P_{g}^{s,t} indicates the output power of the thermal power generator or the hydropower generator g during the operation period t in the operation scenario s, and P_{g}^{min} and P_{g}^{max} indicate the upper and lower limits of the output power of the thermal power generator or the hydropower generator g; and
8) a constraint for upper and lower limits of output power of a wind power generator or a photovoltaic power generator in the power system, expressed by the following expression:
0≤Pᵣ^{s,t}≤P̅ᵣ^{s,t},∀r,∀t,∀s,
wherein, r indicates the serial number of the wind power generator or the photovoltaic power generator in the power system, t indicates the operation period of the power system, s indicates the serial number of an operation scenario in the power system, Pᵣ^{s,t} indicates the output power of the wind power generator or the photovoltaic power generator r during the operation period t in the operation scenario s, and P̅ᵣ^{s,t} indicates the maximum output power of the wind power generator or the photovoltaic power generator r during the operation period t in the operation scenario s.

3. The method of claim 1, wherein solving the optimization model to obtain the optimal investment decision variable comprises:
initializing parameters for solving the optimization model, wherein the number of iteration k is set as k=0, and the initialization value of the investment decision variable uₗ in the optimization model is set as uₗ^{k}=uₗ⁰=0, wherein, k is a positive integer equal to or greater than 0;
substituting the initialization value of the investment decision variable uₗ^{k}=uₗ⁰=0 into the optimization model to obtain N^{CallUnit} operation calculation units, each operation calculation unit corresponding to one operation scenario;
in the k-th iteration in which k is equal to or greater than 1, selecting M^{k} operation calculation units from the N^{CallUnit}, operation calculation units randomly;
solving each of the selected M^{k} operation calculation units to obtain sensitivity-coefficient column vectors δ^{k} and operation cost values C^{k} for the M^{k} operation calculation units;
multiplying the resultant sensitivity-coefficient column vectors δ^{k} and operation cost values C^{k} for the M^{k} operation calculation units by respective conversion coefficients p^{k}, and summing the products, to obtain sensitivity-coefficient column vectors \hat{δ}^{k} and operation cost values Ĉ^{k} in all operation scenarios;
constructing an investment decision master problem according to the sensitivity-coefficient column vectors \hat{δ}^{k} and operation cost values Ĉ^{k} in all operation scenarios;
constructing Benders cuts and adding them into the investment decision master problem, and solving the investment decision master problem, to obtain a current investment decision variable uₗ^{k};
comparing the current investment decision variable uₗ^{k} with a previous investment decision variable uₗ^{k-1} obtained in the (k−1)th iteration;
when the current investment decision variable uₗ^{k} obtained in the kth iteration is different from the previous investment decision variable uₗ^{k-1} obtained in the (k−1)th iteration, updating the selection number of the operation calculation units to M^{k+1}=M^{k}+βN^{CallUnit}, incrementing the number of iteration k by one, and repeating the above steps, wherein β is the learning rate, or when the current investment decision variable uₗ^{k} obtained in the kth iteration is identical to the previous investment decision variable uₗ^{k-1} obtained in the (k−1)th iteration, calculating a sensitivity-coefficient sampling relative error eᵢ for each sensitivity-coefficient element δᵢ^{k} in the sensitivity-coefficient column vectors \hat{δ}^{k} in all operation scenarios, wherein, ∀0≤i≤N^{inv}, and N^{inv} is dimension of the vector \hat{δ}^{k};
comparing the resultant sensitivity-coefficient sampling relative error eᵢ with a relative error upper limit e^{R}; and
when eᵢ≤e^{R}, ∀0≤i≤N^{inv}, outputting the current investment decision variable uₗ^{k} as said optimal investment decision variable, or when eᵢ>e^{R}, ∃0≤i≤N^{inv}, updating the selection number of the operation calculation units to M^{k+1}=M^{k}+βN^{CallUnit}, incrementing the number of iteration k by one, and repeating the above steps.

4. The method of claim 3, wherein solving each of the selected M^{k} operation calculation units to obtain the sensitivity-coefficient column vectors δ^{k} and the operation cost values C^{k} for the M^{k} operation calculation units comprises:
solving the m-th operation calculation unit in the selected M^{k} operation calculation units to obtain a sensitivity-coefficient column vector δ^{k,m} and an operation cost value C^{k,m} for the m-th operation calculation unit, m=1, 2, 3 . . . M^{k}; and
obtaining the sensitivity-coefficient column vectors δ^{k} and the operation cost values C^{k} for all the M^{k} operation calculation units by traversing the M^{k} operation calculation units.

5. The method of claim 4, wherein the sensitivity-coefficient column vectors \hat{δ}^{k} and the operation cost values Ĉ^{k} in all operation scenarios are calculated by the following expressions:
$${\hat{δ}}^{k} = {\sum }_{m = 1}^{{M}^{k}} {p}^{k , m} {δ}^{k , m} , \\ {\hat{C}}^{k} = {\sum }_{m = 1}^{{M}^{k}} {p}^{k , m} {C}^{k , m} , \\ {p}^{k , m} = \frac{{N}^{CalUnit}}{{M}^{k}} ,$$
wherein, p^{k,m} is a conversion coefficient corresponding to the sensitivity-coefficient column vector δ^{k,m} and the operation cost value C^{k,m} for the m-th operation calculation unit.

6. The method of claim 3, wherein the investment decision master problem is constructed according to the sensitivity-coefficient column vectors \hat{δ}^{k} and the operation cost values Ĉ^{k} in all operation scenarios, by the following expression:
$$min z$$
$$s . t . {\sum }_{l ∈ {Ω}_{L N}} {c}_{l} {u}_{l} + {\hat{C}}^{1} + {\sum }_{l ∈ {Ω}_{L N}} ( {u}_{l} - {u}_{l}^{0} ) {\hat{δ}}_{l}^{1} \leq z$$
$$…$$
$${\sum }_{l ∈ {Ω}_{L N}} {c}_{l} {u}_{l} + {\hat{C}}^{k - 1} + {\sum }_{l ∈ {Ω}_{L N}} ( {u}_{l} - {u}_{l}^{k - 2} ) {\hat{δ}}_{l}^{k - 1} \leq z$$
$${\sum }_{l ∈ {Ω}_{L N}} {c}_{l} {u}_{l} + {\hat{C}}^{k} + {\sum }_{l ∈ {Ω}_{L N}} ( {u}_{l} - {u}_{l}^{k - 1} ) {\hat{δ}}_{l}^{k} \leq z$$
wherein, z is an auxiliary continuous variable, which satisfies a constraint indicating a Benders cut constraint constructed by the sensitivity-coefficient column vectors \hat{δ}^{k} and the operation cost values Ĉ^{k} in all operation scenarios.

7. The method of claim 3, wherein, when k sensitivity-coefficient column vectors \hat{δ}^{k} in all operation scenarios are obtained through k iterations, assuming that each sensitivity-coefficient element δᵢ^{k} in each of the sensitivity-coefficient column vectors \hat{δ}^{k} in all operation scenarios satisfies an independent and identical distribution, a mean value δ̅ᵢ and a standard deviation \hat{σ}ᵢ are calculated for each sensitivity-coefficient element δᵢ^{k} in the k sensitivity-coefficient column vectors \hat{δ}^{k} in all operation scenarios, respectively,
wherein, the sensitivity-coefficient sampling relative error eᵢ is calculated according to the mean value δ̅ᵢ and the standard deviation \hat{σ}ᵢ within a confidence region range of 95% by the following expression:
$${e}_{i} = \frac{\frac{1.96 {\hat{σ}}_{i}}{\sqrt{K}}}{{\overline{δ}}_{i}} .$$

8. An apparatus for transmission network expansion planning considering extremely large amounts of operation scenarios, comprising:
one or more processors, and
a storage device, configured to store one or more programs,
wherein, when the one or more programs are executed by the one or more processors, the one or more processors are configured to implement a method for transmission network expansion planning considering extremely large amounts of operation scenarios, comprising:
establishing an optimization model for transmission network expansion planning, the optimization model including an objective function for minimizing the sum of investment costs for the transmission lines and expected values of operation costs in the power transmission network, expressed by the following expression:
$$min {\sum }_{l ∈ {Ω}_{L N}} {c}_{l} {u}_{l} + {\sum }_{s ∈ {Ω}_{S}} {α}_{s} {\sum }_{g ∈ {Ω}_{G}} {\sum }_{t ∈ T} F ( {p}_{g}^{s , t} ) + {\sum }_{s ∈ {Ω}_{S}} {α}_{s} {\sum }_{n ∈ {Ω}_{N}} {\sum }_{t ∈ T} {C}^{Cur} {D}_{n}^{s , t} ,$$
wherein, l indicates the serial number of a line in the power system, Ω_{LN} indicates a set of candidate lines in the power system, cₗ indicates the investment costs of a candidate line l, uₗ indicates an investment decision variable of the line l, s indicates the serial number of an operation scenario in the power system, Ω_{S} indicates a set of the operation scenarios in the power system, αₛ indicates the probability of an operation scenario s, having a value equal to a reciprocal of the number of times the operation scenario s has occurred, g indicates the serial number of a thermal power generator or a hydropower generator in the power system, Ω_{G} indicates a set of the thermal power generators and the hydropower generators in the power system, t indicates the operation period of the power system, T indicates the number of operation periods contained in each operation scenario, P_{g}^{s,t} indicates the output power of the thermal power generator or the hydropower generator g during the operation period t in the operation scenario s, F(P_{g}^{s,t}) indicates the operation costs of the thermal power generator or the hydropower generator g when the output power is P_{g}^{s,t}, n indicates the serial number of a node in the power system, Ω_{N} indicates a set of nodes in the power system, C^{Cur} indicates load-shedding costs at the node, and Dₙ^{s,t} indicates the load-shedding amount at the node n during the operation period t in the operation scenario s;
solving the optimization model to obtain an optimal investment decision variable; and
determining the transmission network expansion planning based on the optimal investment decision variable.

9. The apparatus of claim 8, wherein constraints of the optimization model comprise:
1) a node power balance constraint requiring that the input power and the output power at each node in the power system be equal, expressed by the following expression:
$${\sum }_{g ∈ {Ω}_{G} ( n )} {P}_{g}^{s , t} + {\sum }_{r ∈ {Ω}_{R} ( n )} {P}_{r}^{s , t} - {\sum }_{l ∈ {Ω}_{L} ( n 1 )} {f}_{l}^{s , t} + {\sum }_{l ∈ {Ω}_{L} ( n 2 )} {f}_{l}^{s , t} = {L}_{n}^{s , t} + {D}_{n}^{s , t} ,$$
wherein, l indicates the serial number of a line in the power system, g indicates the serial number of the thermal power generator or the hydropower generator in the power system, n indicates the serial number of the node in the power system, t indicates the operation period of the power system, s indicates the serial number of an operation scenario in the power system, Ω_{G} indicates a set of the thermal power generators and the hydropower generators in the power system, P_{g}^{s,t} indicates the output power of the thermal power generator or the hydropower generator g during the operation period t in the operation scenario s, r indicates the serial number of a wind power generator or a photovoltaic power generator in the power system, Ω_{R} indicates a set of the wind power generators and the photovoltaic power generators in the power system, Pᵣ^{s,t} indicates the output power of the wind power generator or the photovoltaic power generator r during the operation period t in the operation scenario s, Ω_{L} indicates a set of all the lines in the power system, including a set of candidate lines Ω_{LN} and a set of existing lines Ω_{LE}, i. e. Ω_{L}={Ω_{LE},Ω_{LN}}, n1 indicates the start node of the line l in the power system, n2 indicates the end node of the line l in the power system, fₗ^{s,t} indicates the power flow on the line l during the operation period t in the operation scenario s, Lₙ^{s,t} indicates the power load demand at the node n during the operation period i in the operation scenario s, and Dₙ^{s,t} indicates the load-shedding amount at the node n during the operation period t in the operation scenario s.
2) a power flow constraint for existing lines in the power system, expressed by the following expression:
$${f}_{l}^{s , t} = \frac{{θ}_{l +}^{s , t} - {θ}_{l -}^{s , t}}{{x}_{i}} , ∀ l ∈ {Ω}_{LE} ,$$
wherein, l indicates the serial number of a line in the power system, fₗ^{s,t} indicates the power flow on the line l during the operation period t in the operation scenario s, θₗ₊^{s,t} and θₗ₋^{s,t} indicates phase angles of the start node and the end node of the line l during the operation period t in the operation scenario s, xₗ indicates the reactance of the line l, and Ω_{LE} indicates a set of existing lines in the power system;
3) a power flow constraint for candidate lines in the power system, expressed by the following expression:
$$( {u}_{l} - 1 ) M \leq {f}_{l}^{s , t} - \frac{{θ}_{l +}^{s , t} - {θ}_{l -}^{s , t}}{{x}_{l}} \leq ( 1 - {u}_{l} ) M , ∀ l ∈ {Ω}_{L N}$$
wherein, l indicates the serial number of a line in the power system, uₗ indicates the investment decision variable of the line l, M indicates the sum of the maximum capacities of all the lines in the power system, fₗ^{s,t} indicates the power flow on the line l during the operation period t in the operation scenario s, θₗ₊^{s,t} and θₗ₋^{s,t} indicates phase angles of the start node and the end node of the line l during the operation period t in the operation scenario s, xₗ indicates the reactance of the line l, and Ω_{LN} indicates a set of candidate lines in the power system;
4) a constraint for load-shedding amount at a node in the power system, expressed by the following expression:
0≤Dₙ^{s,t}≤Dₙ^{max},
wherein, Dₙ^{s,t} indicates the load-shedding amount at the node n during the operation period t in the operation scenario s, and Dₙ^{max} indicates the maximum load-shedding amount at the node n;
5) a power flow capability constraint for existing lines in the power system, expressed by the following expression:
−fₗ^{max}≤fₗ^{s,t}≤fₗ^{max},∀l∈Ω_{LE},
wherein, fₗ^{s,t} indicates the power flow on the line l during the operation period t in the operation scenario s, fₗ^{max} indicates the maximum value of the power flow on the line l, and Ω_{LE} indicates a set of existing lines in the power system;
6) a power flow capability constraint for candidate lines in the power system, expressed by the following expression:
−uₗ*fₗ^{max}≤fₗ^{s,t}≤uₗ*fₗ^{max},∀l∈Ω_{LN},
wherein, uₗ indicates the investment decision variable of the line l, fₗ^{s,t} indicates the power flow on the line l during the operation period t in the operation scenario s, fₗ^{max} indicates the maximum value of the power flow on the line l, and Ω_{LN} indicates a set of candidate lines in the power system;
7) a constraint for upper and lower limits of output power of a thermal power generator or a hydropower generator in the power system, expressed by the following expression:
P_{g}^{min}≤P_{g}^{s,t}≤P_{g}^{max},∀g,∀t,∀s,
wherein, g indicates the serial number of a thermal power generator or a hydropower generator in the power system, t indicates the operation period of the power system, s indicates the serial number of an operation scenario in the power system, P_{g}^{s,t} indicates the output power of the thermal power generator or the hydropower generator g during the operation period t in the operation scenario s, and P_{g}^{min} and P_{g}^{max} indicate the upper and lower limits of the output power of the thermal power generator or the hydropower generator g; and
8) a constraint for upper and lower limits of output power of a wind power generator or a photovoltaic power generator in the power system, expressed by the following expression:
0≤Pᵣ^{s,t}≤P̅ᵣ^{s,t},∀r,∀t,∀s,
wherein, r indicates the serial number of the wind power generator or the photovoltaic power generator in the power system, t indicates the operation period of the power system, s indicates the serial number of an operation scenario in the power system, Pᵣ^{s,t} indicates the output power of the wind power generator or the photovoltaic power generator r during the operation period t in the operation scenario s, and P̅ᵣ^{s,t} indicates the maximum output power of the wind power generator or the photovoltaic power generator r during the operation period t in the operation scenario s.

10. The apparatus of claim 8, wherein when the one or more processors are configured to solve the optimization model to obtain the optimal investment decision variable, the one or more processors are further configured to:
initialize parameters for solving the optimization model, wherein the number of iteration k is set as k=0, and the initialization value of the investment decision variable uₗ in the optimization model is set as uₗ^{k}=uₗ⁰=0, wherein, k is a positive integer equal to or greater than 0;
substitute the initialization value of the investment decision variable uₗ^{k}=uₗ⁰=0 into the optimization model to obtain N^{CallUnit} operation calculation units, each operation calculation unit corresponding to one operation scenario;
in the k-th iteration in which k is equal to or greater than 1, select M^{k} operation calculation units from the N^{CallUnit} operation calculation units randomly;
solve each of the selected M^{k} operation calculation units to obtain sensitivity-coefficient column vectors δ^{k} and operation cost values C^{k} for the M^{k} operation calculation units;
multiply the resultant sensitivity-coefficient column vectors δ^{k} and operation cost values C^{k} for the M^{k} operation calculation units by respective conversion coefficients p^{k}, and sum the products, to obtain sensitivity-coefficient column vectors \hat{δ}^{k} and operation cost values Ĉ^{k} in all operation scenarios;
construct an investment decision master problem according to the sensitivity-coefficient column vectors \hat{δ}^{k} and operation cost values Ĉ^{k} in all operation scenarios;
construct Benders cuts and add them into the investment decision master problem, and solve the investment decision master problem, to obtain a current investment decision variable uₗ^{k};
compare the current investment decision variable uₗ^{k} with a previous investment decision variable uₗ^{k-1} obtained in the (k−1)th iteration;
when the current investment decision variable uₗ^{k} obtained in the kth iteration is different from the previous investment decision variable uₗ^{k-1} obtained in the (k−1)th iteration, update the selection number of the operation calculation units to M^{k+1}=M^{k}+βN^{CallUnit}, increment the number of iteration k by one, and repeat the above steps, wherein β is the learning rate, or when the current investment decision variable uₗ^{k} obtained in the kth iteration is identical to the previous investment decision variable uₗ^{k-1} obtained in the (k−1)th iteration, calculate a sensitivity-coefficient sampling relative error eᵢ for each sensitivity-coefficient element δₗ^{k} in the sensitivity-coefficient column vectors \hat{δ}^{k} in all operation scenarios, wherein, ∀0≤i≤N^{inv}, and N^{inv} is dimension of the vector \hat{δ}^{k};
compare the resultant sensitivity-coefficient sampling relative error eᵢ with a relative error upper limit e^{R}; and
when eᵢ≤e^{R}, ∀0≤i≤N^{inv}, output the current investment decision variable uₗ^{k} as said optimal investment decision variable, or when eᵢ>e^{R}, ∃0≤i≤N^{inv}, update the selection number of the operation calculation units to M^{k+1}=M^{k}+βN^{CallUnit}, increment the number of iteration k by one, and repeat the above steps.

11. The apparatus of claim 10, wherein when the one or more processors are configured to solve the optimization model to solve each of the selected M^{k} operation calculation units to obtain the sensitivity-coefficient column vectors δ^{k} and the operation cost values C^{k} for the M^{k} operation calculation units, the one or more processors are further configured to:
solve the m-th operation calculation unit in the selected M^{k} operation calculation units to obtain a sensitivity-coefficient column vector δ^{k,m} and an operation cost value C^{k,m} for the m-th operation calculation unit, m=1, 2, 3 . . . M^{k}; and
obtain the sensitivity-coefficient column vectors δ^{k} and the operation cost values C^{k} for all the M^{k} operation calculation units by traversing the M^{k} operation calculation units.

12. The apparatus of claim 10, wherein the one or more processors are configured to calculate the sensitivity-coefficient column vectors \hat{δ}^{k} and the operation cost values Ĉ^{k} in all operation scenarios by the following expressions:
$${\hat{δ}}^{k} = {\sum }_{m = 1}^{{M}^{k}} {p}^{k , m} {δ}^{k , m} , \\ {\hat{C}}^{k} = {\sum }_{m = 1}^{{M}^{k}} {p}^{k , m} {C}^{k , m} , \\ {p}^{k , m} = \frac{{N}^{CalUnit}}{{M}^{k}} ,$$
wherein, p^{k,m} is a conversion coefficient corresponding to the sensitivity-coefficient column vector δ^{k,m} and the operation cost value C^{k,m} for the m-th operation calculation unit.

13. The apparatus of claim 10, wherein the one or more processors are configured to construct the investment decision master problem construct according to the sensitivity-coefficient column vectors \hat{δ}^{k} and the operation cost values Ĉ^{k} in all operation scenarios, by the following expression:
$$min z$$
$$s . t . {\sum }_{l ∈ {Ω}_{L N}} {c}_{l} {u}_{l} + {\hat{C}}^{1} + {\sum }_{l ∈ {Ω}_{L N}} ( {u}_{l} - {u}_{l}^{0} ) {\hat{δ}}_{l}^{1} \leq z$$
$$…$$
$${\sum }_{l ∈ {Ω}_{L N}} {c}_{l} {u}_{l} + {\hat{C}}^{k - 1} + {\sum }_{l ∈ {Ω}_{L N}} ( {u}_{l} - {u}_{l }^{k - 2} ) {\hat{δ}}_{l}^{k - 1} \leq z$$
$${\sum }_{l ∈ {Ω}_{L N}} {c}_{l} {u}_{l} + {\hat{C}}^{k} + {\sum }_{l ∈ {Ω}_{L N}} ( {u}_{l} - {u}_{l }^{k - 1} ) {\hat{δ}}_{l}^{k} \leq z$$
wherein, z is an auxiliary continuous variable, which satisfies a constraint indicating a Benders cut constraint constructed by the sensitivity-coefficient column vectors \hat{δ}^{k} and the operation cost values Ĉ^{k} in all operation scenarios.

14. The apparatus of claim 10, wherein, when k sensitivity-coefficient column vectors \hat{δ}^{k} in all operation scenarios are obtained through k iterations, assuming that each sensitivity-coefficient element δᵢ^{k} in each of the sensitivity-coefficient column vectors \hat{δ}^{k} in all operation scenarios satisfies an independent and identical distribution, the one or more processors are further configured to calculate a mean value δ̅ᵢ and a standard deviation \hat{σ}ᵢ for each sensitivity-coefficient element δᵢ^{k} in the k sensitivity-coefficient column vectors \hat{δ}^{k} in all operation scenarios, respectively, and
wherein, the one or more processors are further configured to calculate the sensitivity-coefficient sampling relative error eᵢ according to the mean value δ̅ᵢ and the standard deviation σ̅ᵢ within a confidence region range of 95% by the following expression:
$${e}_{i} = \frac{\frac{1.96 {\hat{σ}}_{i}}{\sqrt{K}}}{{\overline{δ}}_{i}} .$$

15. A non-transitory computer readable storage medium having a computer program stored thereon, wherein, when the program is executed by a processor, the program implements a method for transmission network expansion planning considering extremely large amounts of operation scenarios, comprising:
establishing an optimization model for transmission network expansion planning, the optimization model including an objective function for minimizing the sum of investment costs for the transmission lines and expected values of operation costs in the power transmission network, expressed by the following expression:
$$min {\sum }_{l ∈ {Ω}_{L N}} {c}_{l} {u}_{l} + {\sum }_{s ∈ {Ω}_{S}} {α}_{s} {\sum }_{g ∈ {Ω}_{G}} {\sum }_{t ∈ T} F ( {p}_{g}^{s , t} ) + {\sum }_{s ∈ {Ω}_{S}} {α}_{s} {\sum }_{n ∈ {Ω}_{N}} {\sum }_{t ∈ T} {C}^{Cur} {D}_{n}^{s , t} ,$$
wherein, l indicates the serial number of a line in the power system, Ω_{LN} indicates a set of candidate lines in the power system, cₗ indicates the investment costs of a candidate line l, uₗ indicates an investment decision variable of the line l, s indicates the serial number of an operation scenario in the power system, Ω_{S} indicates a set of the operation scenarios in the power system, αₛ indicates the probability of an operation scenario s, having a value equal to a reciprocal of the number of times the operation scenario s has occurred, g indicates the serial number of a thermal power generator or a hydropower generator in the power system, Ω_{G} indicates a set of the thermal power generators and the hydropower generators in the power system, t indicates the operation period of the power system, T indicates the number of operation periods contained in each operation scenario, P_{g}^{s,t} indicates the output power of the thermal power generator or the hydropower generator g during the operation period t in the operation scenario s, F(P_{g}^{s,t}) indicates the operation costs of the thermal power generator or the hydropower generator g when the output power is P_{g}^{s,t}, n indicates the serial number of a node in the power system, Ω_{N} indicates a set of nodes in the power system, C^{Cur} indicates load-shedding costs at the node, and Dₙ^{s,t} indicates the load-shedding amount at the node n during the operation period t in the operation scenario s;
solving the optimization model to obtain an investment decision variable; and
determining the transmission network expansion planning based on the optimal investment decision variable.
